(19) United States
(12) Patent Application Publication
(10) Pub. No.: US 2025/0269253 A1
(43) Pub. Date: Aug. 28, 2025

(54) PICKLEBALL PADDLE INLAY WITH METALLIC LATTICE COMPOSITE STRUCTURE

(71) Applicant: Selkirk Sport, LLC, Coeur d'Alene, ID (US)

(72) Inventors: Robert James Barnes, Hayden, ID (US); Michael Eisele, Hayden, ID (US); Thomas Barnes, Hayden, ID (US)

(21) Appl. No.: 19/061,496

(22) Filed: Feb. 24, 2025

Related U.S. Application Data
(60) Provisional application No. 63/557,262, filed on Feb. 23, 2024.

(51) Int. Cl. A63B 59/42; A63B 102/08; B32B 3/12; B32B 15/02; B32B 37/18

(52) U.S. Cl. CPC A63B 59/42; B32B 3/12; B32B 15/02; B32B 37/18; A63B 2102/08; A63B 2209/02; B32B 2311/18

(57) ABSTRACT

A paddle includes a core and at least one metallic lattice structure coupled to the core.

### CROSS REFERENCE TO RELATED PATENT APPLICATIONS

This application is a non-provisional application which claims priority from U.S. Provisional Patent Application No. 63/557,262, filed on Feb. 23, 2024, and incorporates the content thereof in its entirety by reference.

### TECHNICAL FIELD

The present disclosure relates generally to sport equipment. Specifically, the present disclosure relates to paddles such as pickleball paddles that include metal lattice structures.

### BACKGROUND

Pickleball is an indoor or outdoor paddle sport in which two (singles) or four (doubles) players hit a perforated, hollow plastic ball with paddles over a 34-inch-high net until one side is unable to return the ball or commits an fault by violating a rule.

As the sport of pickleball has advanced, the demand for improved and sophisticated equipment requires innovations that can handle competitive play. Some pickleball paddles on the market are not capable of providing play-enhancing features that increase the effectiveness of a player. Additionally, some of the equipment available is less durable than others, and under competitive use, it is important that the players have reliable and durable equipment to provide them with competitive use. Therefore, it is desirable to address a specific deficiency in the realm of pickleball sporting equipment and develop a high-performance pickleball paddle capable of enduring the rigorous demands of competitive play.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an exploded, isometric view of a paddle, according to an example of the principles described herein.

FIG. 2 illustrates a metallic lattice structure, according to an example of the principles described herein.

FIG. 3 illustrates a metallic lattice structure, according to an example of the principles described herein.

FIG. 4 illustrates a metallic lattice structure, according to an example of the principles described herein.

FIG. 5 illustrates a metallic lattice structure, according to an example of the principles described herein.

FIG. 6 illustrates a metallic lattice structure, according to an example of the principles described herein.

FIG. 7 illustrates a metallic lattice structure, according to an example of the principles described herein.

FIG. 8 illustrates a flow diagram of an example method of manufacturing a paddle, according to an example of the principles described herein.

### DESCRIPTION OF EXAMPLE EMBODIMENTS

### Overview

The present disclosure provides for a paddle with superior play performance. This may include a paddle design that significantly enhances player control, increases power output, and extends durability, without compromising other critical performance metrics. The combination of advanced materials and composite structures has led to significant innovations in sports equipment including in pickleball paddles. In an embodiment, the paddle may include a core and a layer including a metallic lattice structure, which layer with the metallic lattice structure may be directly coupled to the core or indirectly coupled to the core. Furthermore, the metallic lattice structure may include a metal or metal alloy. For example, in an embodiment, the metallic lattice structure may include a titanium, a titanium alloy, or a treated metal.

In an embodiment, the paddle may further include an intermediate layer coupled to the core and the layer of the metallic lattice structure. In an embodiment, the paddle may further include at least one outer layer coupled to the at least one intermediate layer or the layer of the metallic lattice structure. Additionally, and/or alternatively, in an embodiment, the paddle may include at least one outer layer coupled to the at least one metallic lattice structure or the intermediate layer, if an intermediate layer is included.

In an embodiment, the layer with the metallic lattice structure may include at least one of a wireframe lattice structure, a dimpled lattice structure, a perforated lattice structure, an expanded lattice structure, a flattened expanded lattice structure, a corrugated lattice structure, a wire netting lattice structure, a wire-mesh lattice structure, or a woven mesh lattice structure. In an embodiment, the core may include a honeycomb architecture.

This disclosure describes a paddle and techniques for forming or manufacturing a paddle that includes a metallic lattice structure. The example paddles described herein introduce a reinforced metal lattice structure within a composite pickleball paddle. The inclusion of the metal lattice structure may enhance the durability, power, and control of play of the paddle. By leveraging the advanced materials and manufacturing techniques described herein, the paddle may offer a groundbreaking solution to improve player performance and satisfaction. Further, the paddle including the metal lattice structure may represent a major advancement in sports equipment design and sets a new standard for pickleball paddle construction. Embedding a reinforced metal lattice within composite pickleball paddles is a significant innovation in pickleball equipment. It utilizes advanced materials and composite construction techniques to produce paddles that may improve player performance and enjoyment.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

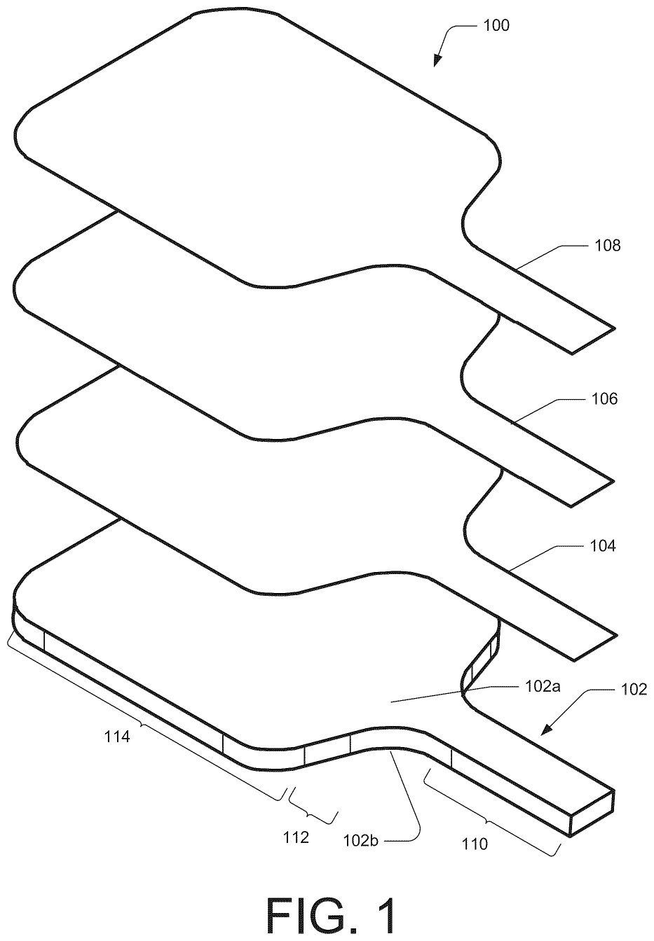

FIG. 1 illustrates an exploded, isometric view of a paddle 100 (e.g., a completed paddle ready for play, a paddle blank, an incomplete paddle for further processing), according to an example of the principles described herein. In other words, the use of the term paddle hereinafter, and as claimed, may refer to either a paddle that is considered completely finished and is ready for play (competitive or casual); or an incomplete paddle that is not in a finished state for play, but rather is only a stage of processing and has had some elements of a paddle, and therefore may be embodied as claimed hereinafter. Such an incomplete paddle may also be referred to as a paddle blank, which is ready for further finishing stages, perhaps in a different facility.

In an embodiment, the paddle 100 may include a core 102 as a base layer that serves as a foundational substrate portion of the paddle 100. As discussed further hereinafter, the paddle 100 may include a first layer 104, a second layer 106, and/or a third layer 108. In an embodiment, the paddle 100 may be formed in the specifically shown arrangement, with the first layer 104 placed on a surface 102a of core 102, which is sandwiched between the core 102 and the second layer 106. In an embodiment, the second layer 104 may be sandwiched between the first layer 104 and the third layer 108. However, in an embodiment (not shown explicitly), the first layer 104 may be placed on surface 102a and/or a surface 102b that is opposite surface 102a on core 102. Likewise with the placement of one or more second layers 106 and one or more third layers 108. To be clear, in an embodiment, the first layer 104, the second layer 106, and/or the third layer 108, may be duplicated and placed on the opposite side of core 102.

Furthermore, the body of the paddle 100 may include, for example, a handle portion 110 (“handle”), a neck portion 112 (“neck”), and a head portion 114 (“head”). The paddle 100 may be further defined by additionally narrowly defined sections or features known in existing paddles, including but not limited to, an outer perimeter that surrounds at least the central region of the playing face in the head portion, and the throat (at least a part of which may be part of the playable face and may extend part way into the handle region). In addition, the paddle 100 may further include one or more of an edge guard coupled to an edge of the paddle, pallets that form part of the handle, a grip, an end cap coupled to an end of the handle, and a rubber or silicone band coupled to an end of the handle opposite the end cap.

As discussed above, the metallic lattice structure may be applied to all or a portion of the paddle 100. In an embodiment, although the first layer 104, the second layer 106 and the third layer 108 are depicted in FIG. 1 as covering substantially all of the portion of the core 102, in one example, the first layer 104, the second layer 106 and/or the third layer 108 may cover less than an entirety of the surface area of the paddle 100. For example, the first layer 104, the second layer 106 and/or the third layer 108 may cover less than all of the handle 110, the neck 112, and the head 114 such as the just the head 114 and not the neck 112 of the handle 110.

In an embodiment, the paddle 100 may include an intermediate layer coupled to the core 102 and the metallic lattice structure. In this example, the intermediate layer may be the first layer 104. Further, in an embodiment, the metallic lattice structure may be embodied as the second layer 106 and/or the third layer 108.

In an embodiment, the paddle 100 may include an intermediate layer coupled to the metallic lattice structure and an outer layer. In an embodiment, the intermediate layer may be embodied as the second layer 106, the metallic lattice structure may be the first layer 104, and the outer layer may be embodied as the third layer 108.

In an embodiment, both the first layer 104 and the second layer 106 may include a metallic lattice structure. In an embodiment, a first metallic lattice structure may be embodied as the first layer 104 and may be coupled to the core 102, and a second metallic lattice structure may be embodied as the second layer 106 and may be coupled to the first metallic lattice structure (e.g., the first layer 104). The outer layer may be the third layer 108 and may be coupled to the second metallic lattice structure (e.g., the second layer 106).

In an embodiment, the metallic lattice structure may be embodied as the outer layer such as the third layer 108. However, as stated above, in an embodiment, the metallic lattice structure may be included as any of the first layer 104, the second layer 106, and/or the third layer 108. For any of the first layer 104, the second layer 106, and the third layer 108 that does not include a metallic lattice structure, those layer(s) may include, for example, a woven or non-woven carbon fiber, a woven or non-woven fabric, a fiberglass, a polymer, a metal or metal alloy, a cork, a wood, or other materials. Further, in an embodiment, the outer layer such as the third layer 108 may include a fiberglass, a plastic, a metal or metal alloy, or other material.

The metallic lattice structure that may be included as the first layer 104, the second layer 106, and/or the third layer 108 and may form part of a composite layer of the paddle 100. The composite layer of the paddle 100 may include, for example, the first layer 104, the second layer 106 and/or the third layer 108. Further, the composite layer of the paddle 100 may be formed as a whole before application to the paddle 100 including one or more of the first layer 104, the second layer 106, and/or the third layer 108. The aspects of the above description applies to the composite layer of the paddle 100.

In an embodiment, the core 102 may be a rigid material or a flexible material. In either case, the material of the core may be reinforced to provide a measure of, or an increase in, the stiffness/rigidity characteristic of the paddle 100 by adding one or more additional layers of material. The “additional layers” may include any of those layers (104, 106, 108) described further hereinafter, or such stiffness may be provided by means other than via the additional layers (104, 106, 108) discussed in this disclosure. For example, though depicted as a solid, continuously consistent material in FIG. 1, the core 102 may include additional elements of structural formation for rigidity or strength, such as a composite of one or more materials and/or one or more architectural frameworks (e.g., shape structure, substructure, substructural frame, frame, skeleton, etc.). For example, in an embodiment, the core 102 may include a honeycomb architectural framework. A substructural frame may be found in a portion (e.g., a center region of the head, the entire head, the handle, the neck, the throat, a peripheral region of any of the aforementioned areas) of the core 102 of the paddle 100, or throughout the core 102 (i.e., side to side, border to border, end to end, etc.). However, in light of the endless possibilities of the base architectures available, FIG. 1 depicts the core 102 as having a continuous playing surface with no visible underlying substructure. Further, the core 102 may be made of any suitable material or a composition of materials. In an embodiment, the material of the core 102 (either the entirety, a portion of, the architectural framework, and/or the filler material) may include, for example, one or more metals such as aluminum, metal alloys, polymers with or without composite fibers/fibrous material, such as Nomex®, etc.

As indicated above, the paddle 100 may include one or more of a plurality of layers of materials on at least one face of the paddle 100. In an embodiment, the plurality of layers (104, 106, 108) may be applied to both a first face (e.g., surface 102a) and a second face (e.g., surface 102b) of the paddle 100 to provide the qualities of the plurality of layers described herein on both faces. In an embodiment, the first face of the paddle 100 may include fewer, equal, or more layers of material and/or the layers may be of different characteristics or materials as compared to the layer or layers (if any) on the second side. In other words, while the layers described herein are described as shown with respect to the first side of the paddle 100, the layers may be similarly applied to the second side of the paddle as well.

In an embodiment, the first layer 104, the second layer 106, and/or the third layer 108 may include a substrate (e.g., sheet) of a metallic lattice structure, or of a non-metal (either in a lattice structure or as a continuous solid material) directly or indirectly coupled to the core 102. For the purposes of this application, the term “lattice” may define any two-dimensionally extending structure formed using, or being shaped to appear as, strips or interconnected rows of material that are crossed, overlapping, woven, wrapped, affixed, aligned, dimpled, bubbled, entangled, etc. or otherwise engaged in any of a variety of manners, where the “strips” of material fastened (e.g., molded, melted, stuck, embedded, cast, fixed, arranged, stuck, pressed, etc.) together in a structure that has a sheet shape (e.g., extending two-dimensionally, with a predetermined thickness in the third dimension). That is, a layer (104, 106, 108) with a lattice may be formed with a three-dimensional direction thickness that is initially thicker than desired for the layer (104, 106, 108) to be implemented in the paddle 100, but which may be reduced to a desired thickness. Alternatively, the lattice structure may be formed directly as the desired thickness. Although three layers are depicted in FIG. 1, including the first layer 104, the second layer 106, and/or the third layer 108, more or fewer layers may be included in the paddle 100.

In an embodiment, the first layer 104, the second layer 106, and/or the third layer 108 may include a metallic lattice structure as described herein. Thus, a layer with the metallic lattice structure may be directly coupled to the core 102, as in the case of the first layer 104, or indirectly coupled to the core 102, as in the case of the second layer 106, and/or as in the third layer 108, which may be coupled directly to the second layer 106.

In an embodiment, the metallic lattice structure may include a metal or metal alloy. For example, in an embodiment, the metallic lattice structure may be formed of a titanium or a titanium alloy, which may provide corrosion resistance, a superior strength-to-weight ratio, low density, high heat-resistance, high heat transfer capability, good oxidation capabilities, a high melting point, a low elasticity module, excellent erosion resistance, low thermal expansion coefficient, etc., all of which assist in manufacturing a paddle that assist in providing superior quality during play. Although titanium and titanium alloys are described herein in connection with the metallic lattice structure, any material may be used in connection with the paddle 100. In an embodiment, the metallic lattice structure may include a treated metal.

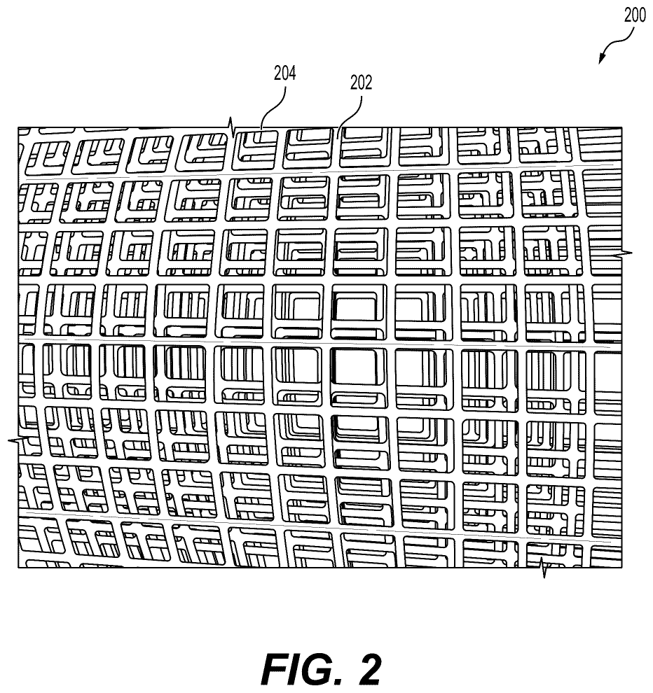

The metallic lattice structure may include any lattice structure or architecture that may assist in imparting structural and/or performance benefits to the paddle 100. For example, in embodiment as seen in FIG. 2, the metallic lattice structure 200 may include a wireframe lattice structure including overlapping vertical wires 202 and horizontal wires 204 that make up the lattice structure 200. For example, in an embodiment, the metallic lattice structure 200 of FIG. 2 may include a heavy wire mesh in which heavy gauged wires are formed and coupled at approximately 90-degree angles. The wire in the example metallic lattice structure 200 of FIG. 2 may have any gauge and may be spaced at any distance from one another.

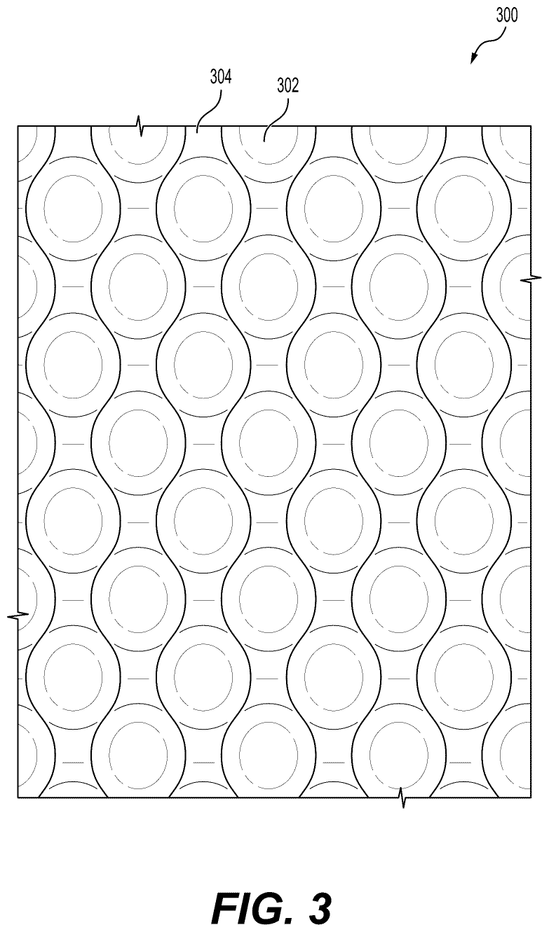

In an alternative embodiment as seen in FIG. 3, the metallic lattice structure 300 may include a dimpled lattice structure 300 in which dimpling or other patterned or regular indentations 302 are formed in a surface of, for example, a metal sheet 304 (portions between the dimpling) to form a lattice structure 300 with regular dimpling along the surface of the metal sheet. The dimples 302 formed in the metallic lattice structure 300 may have any size, dimensions, and shapes including sizes and dimensions associated with an outer perimeter, depth, and other features of the dimples 302.

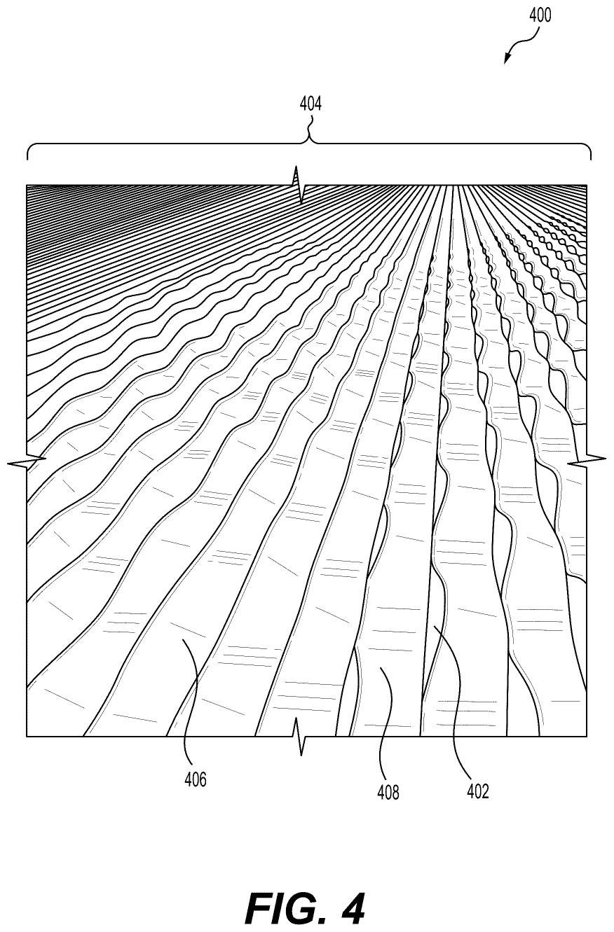

In an alternative embodiment as seen in FIG. 4, the metallic lattice structure 400 may include a perforated lattice structure 400 in which a pattern of apertures 402 is formed in the surface of the metallic lattice structure 400 along a length and/or width of, for example, a metal sheet 404. By pressing or cutting the apertures 402 into the sheet, the lattice structure 400 may form a series of horizontal or vertical rows of sequential peaks 406 and valleys 408.

The apertures defined in the metal sheet 402 may have any shape and dimensions. The perforations may be formed by punching or cutting the third metallic lattice structure 400. The lattice structure 400 may be described as a plurality of columns of waveform shapes that have troughs (408) and peaks (406) that alternate with each other side by side. The perforations/apertures 402 of the metallic lattice structure 400 may form any series of shapes or features.

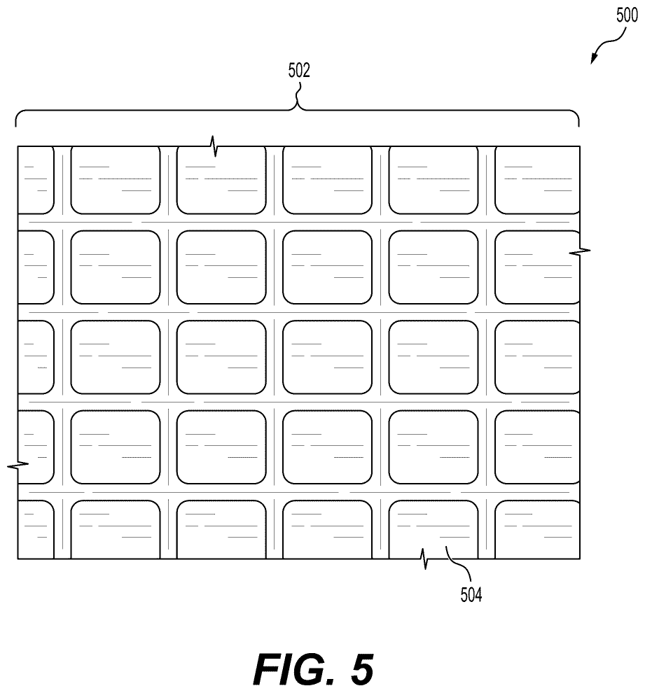

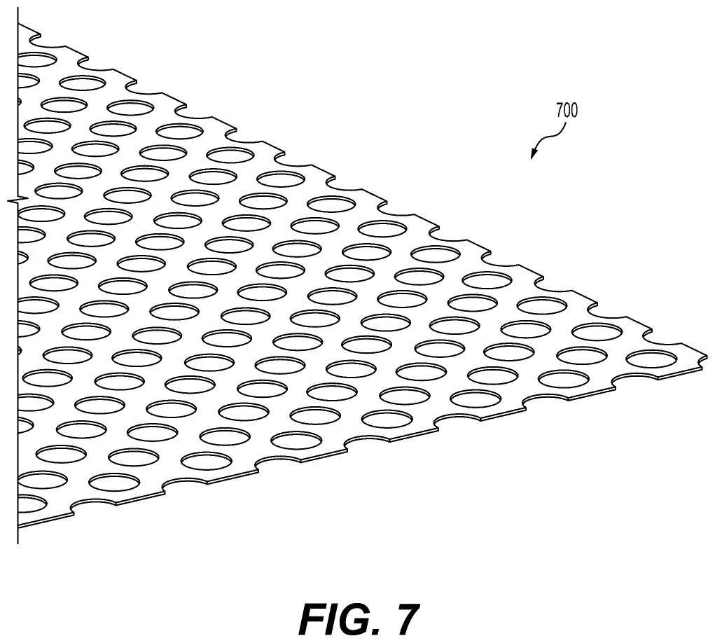

In an alternative embodiment as seen in FIG. 5, the metallic lattice structure may include an expanded lattice structure 500. The expanded lattice structure 500 may include, for example, a monolithic lattice structure that is a flattened metal sheet 502 having a repeated series of cuts/punches/holes/openings/apertures 504, that results in a regular pattern presenting a mesh-like material (e.g., having a rectangular-shaped, square-shaped, diamond-shaped, circular-shaped (see FIG. 7), or other shaped series of patterned apertures). Notably, the apertures 504 may be formed through cutting, stamping, molding or other additive or subtractive manufacturing process. Expanded metal sheets may be relatively stronger than an equivalent weight of, for example, wire mesh, since the material is flattened, allowing the metal to stay in one piece. Further, because expanded metal is never completely cut and reconnected, the material may retain its original strength. In one example, the expanded lattice 500 may include a flattened expanded lattice structure in which the metal sheet is rolled flat or otherwise flattened after being cut to produce an even and flat surface across the openings created by the cutting.

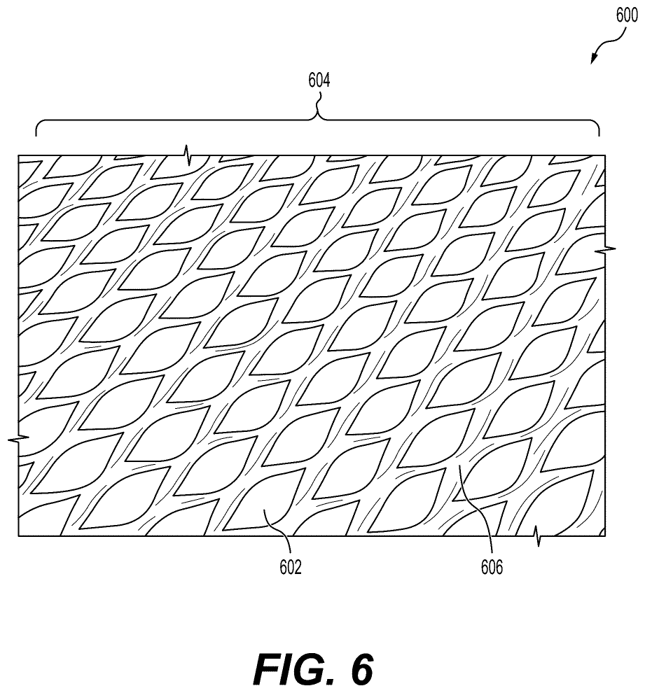

In an alternative embodiment as seen in FIG. 6, the metallic lattice structure 600 may include an expanded, stretched, corrugated lattice structure 600 in which corrugated openings 602 are formed in the metal sheet 604 between remaining connected segments 606. In an embodiment, the corrugated lattice structure 600 may be cut and stretched to produce a linear ridged pattern in the metal sheet 602. The cut and stretched metal sheet 604 results in the formation of a regular pattern (e.g., a diamond-shaped pattern) of mesh-like material. In an embodiment, the metallic lattice structure may include a wire-mesh lattice structure or a woven mesh lattice structure. The corrugations increase the bending strength of the corrugated lattice structure 600 in the direction perpendicular to the corrugations, but not parallel to the corrugations. In an embodiment, the corrugated lattice structure 600 may be manufactured longer in its strong direction. The wire-mesh lattice structure or woven mesh lattice structure may include a metal mesh that may be, for example, woven, knitted, welded, expanded, sintered, photo-chemically etched, or electroformed, for example.

In an alternative embodiment, the metallic lattice structure may include a wire netting lattice structure (not specifically shown). The wire netting lattice structure may include, for example, wires that run vertically and are bent into a zig-zag pattern so that each “zig” hooks with a wire immediately on one side and each “zag” with the wire immediately on the other. This may form a diamond pattern.

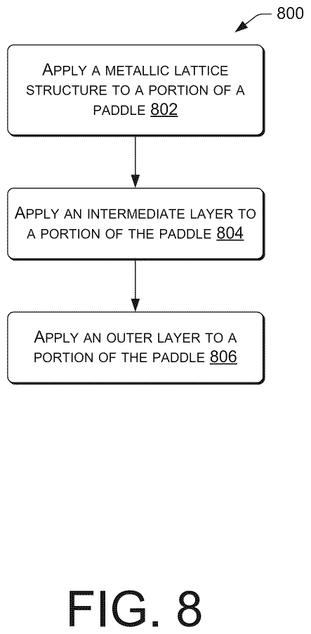

FIG. 8 illustrates a flow diagram of an example method 800 of manufacturing a paddle 100, according to an example of the principles described herein. The method 800 may include, at 802, applying a (one or more) metallic lattice structure to a portion of the paddle 100. In an embodiment, the metallic lattice structure may be embodied as any of the first layer 104, the second layer 106, and/or the third layer 108. The method 800 may further include applying an (one or more) intermediate layer to a portion of the paddle 100. The intermediate layer may be applied as any of the first layer 104, the second layer 106, and/or the third layer 108. The method 800 may further include applying at an (one or more) outer layer to a portion of the paddle 100. The outer layer may be embodied as, for example, the third layer 108. Although the method 800 includes application of a number of layers including the metallic lattice structure, the intermediate layer, and/or the outer layer, any quantity or order of layers may be applied to the core 102 of the paddle 100.

In an embodiment, the method 800 may include starting with creating composite materials for pickleball paddles 100. A reinforced metal lattice structure, made up of interconnected elements, may then be embedded within the composite layers to strengthen areas most likely to experience stress during play. Advanced manufacturing techniques such as automated fiber placement or resin infusion may be used to precisely integrate the metal lattice structure within the composite structure. However, traditional composite layup techniques may also be used. This results in paddles 100 that are notably mechanically different from traditional composite structures used in pickleball. The uniqueness of the paddles 100 described herein comes from its ability to improve paddle performance for pickleball. Using the metal lattice structure may increase power, control, maneuverability, and durability, and may enhance the playing experience for a user.

### CONCLUSION

The examples described herein provide a paddle that includes at least one metallic lattice structure. Integrating a reinforced metal lattice structure within composite pickleball paddles or other paddles marks a significant advancement in pickleball equipment design. This approach combines the lightweight nature of composite materials with the strength and durability of metal and results in a high-performing, durable, and satisfying paddle.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure, and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A paddle comprising:
a core; and
at least one metallic lattice structure coupled to the core.

2. The paddle of claim 1, wherein the at least one metallic lattice structure is directly coupled to the core or indirectly coupled to the core.

3. The paddle of claim 1, wherein the at least one metallic lattice structure includes a metal or metal alloy.

4. The paddle of claim 1, wherein the at least one metallic lattice structure includes a titanium or titanium alloy.

5. The paddle of claim 1, wherein the at least one metallic lattice structure includes a treated metal.

6. The paddle of claim 1, further comprising at least one intermediate layer coupled to the core and the at least one metallic lattice structure.

7. The paddle of claim 6, further comprising at least one outer layer coupled to the at least one intermediate layer.

8. The paddle of claim 1, further comprising at least one outer layer coupled to the at least one metallic lattice structure.

9. The paddle of claim 1, wherein the at least one metallic lattice structure includes at least one of a wireframe lattice structure, a dimpled lattice structure, a perforated lattice structure, an expanded lattice structure, a flattened expanded lattice structure, a corrugated lattice structure, a wire netting lattice structure, a wire-mesh lattice structure, or a woven mesh lattice structure.

10. The paddle of claim 1, wherein the core includes a honeycomb architecture.

11. A composite layer of a paddle comprising at least one metallic lattice structure.

12. The composite layer of claim 11, wherein the at least one metallic lattice structure is directly coupled to a core or indirectly coupled to the core.

13. The composite layer of claim 11, wherein the at least one metallic lattice structure includes a metal or metal alloy.

14. The composite layer of claim 11, wherein the at least one metallic lattice structure includes a titanium or titanium alloy.

15. The composite layer of claim 11, wherein the at least one metallic lattice structure includes a treated metal.

16. The composite layer of claim 11, further comprising at least one intermediate layer coupled to the at least one metallic lattice structure.

17. The composite layer of claim 16, further comprising at least one outer layer coupled to the at least one intermediate layer.

18. The composite layer of claim 11, further comprising at least one outer layer coupled to the at least one metallic lattice structure.

19. The composite layer of claim 11, wherein the at least one metallic lattice structure includes at least one of a wireframe lattice structure, a dimpled lattice structure, a perforated lattice structure, an expanded lattice structure, a flattened expanded lattice structure, a corrugated lattice structure, a wire netting lattice structure, a wire-mesh lattice structure, or a woven mesh lattice structure.

20. A method of manufacturing a paddle, comprising applying at least one metallic lattice structure to a portion of a paddle.

21. The method of claim 20, wherein applying the at least one metallic lattice structure to a portion of a paddle includes applying the at least one metallic lattice structure directly or indirectly to a core.

22. The method of claim 21, wherein the core includes a honeycomb architecture.

23. The method of claim 20, wherein the at least one metallic lattice structure includes a metal or metal alloy.

24. The method of claim 20, wherein the at least one metallic lattice structure includes a titanium or titanium alloy.

25. The method of claim 20, wherein the at least one metallic lattice structure includes a treated metal.

26. The method of claim 20, further comprising applying at least one intermediate layer coupled to the at least one metallic lattice structure.

27. The method of claim 26, further comprising applying at least one outer layer to the at least one intermediate layer.

28. The method of claim 20, further comprising applying at least one outer layer to the at least one metallic lattice structure.

29. The method of claim 20, wherein the at least one metallic lattice structure includes at least one of a wireframe lattice structure, a dimpled lattice structure, a perforated lattice structure, an expanded lattice structure, a flattened expanded lattice structure, a corrugated lattice structure, a wire netting lattice structure, a wire-mesh lattice structure, or a woven mesh lattice structure.
